(19) United States
(12) Patent Application Publication
(10) Pub. No.: US 2025/0119909 A1
(43) Pub. Date: Apr. 10, 2025

(54) SYSTEMS AND METHODS FOR TIMING CONTROL AND UCI MULTIPLEXING IN MULTI-TRP MULTI-PANEL OPERATION

(71) Applicant: Intel Corporation, Santa Clara, CA (US)

(72) Inventors: Gang Xiong, Portland, OR (US); Alexei Davydov, Santa Clara, CA (US); Bishwarup Mondal, San Ramon, CA (US); Dong Han, Santa Clara, CA (US)

(21) Appl. No.: 18/833,337

(22) PCT Filed: Apr. 13, 2023
(86) PCT No.: PCT/US2023/065713

§ 371 Date: Jul. 25, 2024

Related U.S. Application Data
(60) Provisional application No. 63/330,930, filed on Apr. 14, 2022.
(60) Provisional application No. 63/334,018, filed on Apr. 22, 2022.

(51) Int. Cl. H04W 72/1268; H04W 76/38

(52) U.S. Cl. CPC H04W 72/1268; H04W 76/38

(57) ABSTRACT

Various embodiments herein provide techniques for uplink control information (UCI) multiplexing in multi—transmission-reception point (TRP) multi-panel operation. For example, the UCI may be multiplexed on a physical uplink shared channel (PUSCH) and/or a physical uplink control channel (PUCCH). Embodiments further include techniques for handling collision between PUSCH and PUCCH with different priorities. Additionally, embodiments include techniques for timing control for multi-TRP multi-panel operation. Other embodiments may be described and claimed.

### CROSS REFERENCE TO RELATED APPLICATION

The present application claims priority to U.S. Provisional Patent Application No. 63/330,930, which was filed Apr. 14, 2022; and to U.S. Provisional Patent Application No. 63/334,018, which was filed Apr. 22, 2022.

### FIELD

Various embodiments generally may relate to the field of wireless communications. For example, some embodiments may relate to timing control and/or uplink control information (UCI) multiplexing in multi-transmission-reception point (TRP) multi-panel operation.

### BACKGROUND

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple, and seamless wireless connectivity solutions. NR will enable everything connected by wireless and deliver fast, rich contents and services.

For 5G system, high frequency band communication has significantly attracted attention from the industry, since it can provide wider bandwidth to support the future integrated communication system. The beam forming is a critical technology for the implementation of high frequency band system due to the fact that the beam forming gain can compensate the severe path loss caused by atmospheric attenuation, improve the SNR, and enlarge the coverage area. By aligning the transmission beam to the target UE, radiated energy is focused for higher energy efficiency, and mutual UE interference is suppressed.

In NR, multiple transmission-reception points (TRP)s can be utilized to transmit and receive data and control channel, which can help in improving the reliability for communication. In 3GPP Release (Rel)-17, for UE that is equipped with a panel, a single Tx beam is formed for a given time. In this case, different transmit beams or beam sweeping can be applied for the repetition of uplink transmission including physical uplink shared channel (PUSCH) and physical uplink control channel (PUCCH) to exploit the benefits of spatial diversity. In particular, beam mapping pattern between repetitions and TRPs can be either cyclic mapping or sequential mappings.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of multi-transmission-reception point (TRP) multi-panel operation for uplink transmission, in accordance with various embodiments.

FIG. 2 illustrates an example of uplink control information (UCI) multiplexing on physical uplink shared channel (PUSCH), in accordance with various embodiments.

FIG. 3 illustrates an example of UCI multiplexing on physical uplink control channel (PUCCH), in accordance with various embodiments.

FIG. 4 illustrates another example of UCI multiplexing on PUSCH, in accordance with various embodiments.

FIG. 5 illustrates an example of UCI multiplexing with different priorities, in accordance with various embodiments.

FIG. 6 schematically illustrates another example of UCI multiplexing with different priorities, in accordance with various embodiments.

FIG. 7 illustrates an example of simultaneous multi-TRP uplink transmission and associated time-frequency resources, in accordance with various embodiments.

FIG. 8 illustrates an example of a timing advance command medium access control (MAC) control element (CE), in accordance with various embodiments.

FIG. 9 illustrates an example of an absolute timing advance MAC CE, in accordance with various embodiments.

FIG. 10 illustrates an example of a single-TRP downlink and uplink transmission timing relation, in accordance with various embodiments.

FIG. 11 illustrates an example of a multi-TRP downlink and uplink transmission timing relation with two timing advances (TAs), in accordance with various embodiments.

FIG. 12 illustrates an example of a multi-TRP downlink and uplink transmission timing relation with one TA and one TA offset, in accordance with various embodiments.

FIG. 13 illustrates an example of multi-TRP downlink and uplink transmission timing relation with perfect synchronization, in accordance with various embodiments.

FIG. 14 schematically illustrates a wireless network in accordance with various embodiments.

FIG. 15 schematically illustrates components of a wireless network in accordance with various embodiments.

FIG. 16 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 17, 18, and 19 depict example procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Various embodiments herein provide techniques for uplink control information (UCI) multiplexing in multi—transmission-reception point (TRP) multi-panel operation. For example, the UCI may be multiplexed on a physical uplink shared channel (PUSCH) and/or a physical uplink control channel (PUCCH). Embodiments further include techniques for handling collision between PUSCH and PUCCH with different priorities. Additionally, embodiments include techniques for timing control for multi-TRP multi-panel operation.

### UCI Multiplexing for Multi-TRP Multi Panel Operation

As discussed above, multiple TRPs may be utilized to transmit and receive data and control channels. In 3GPP Rel-17, for UE that is equipped with a panel, a single transmit (Tx) beam is formed for a given time. In this case, different transmit beams or beam sweeping can be applied for the repetition of uplink transmission including PUSCH and PUCCH to exploit the benefits of spatial diversity. In particular, beam mapping pattern between repetitions and TRPs can be either cyclic mapping or sequential mappings.

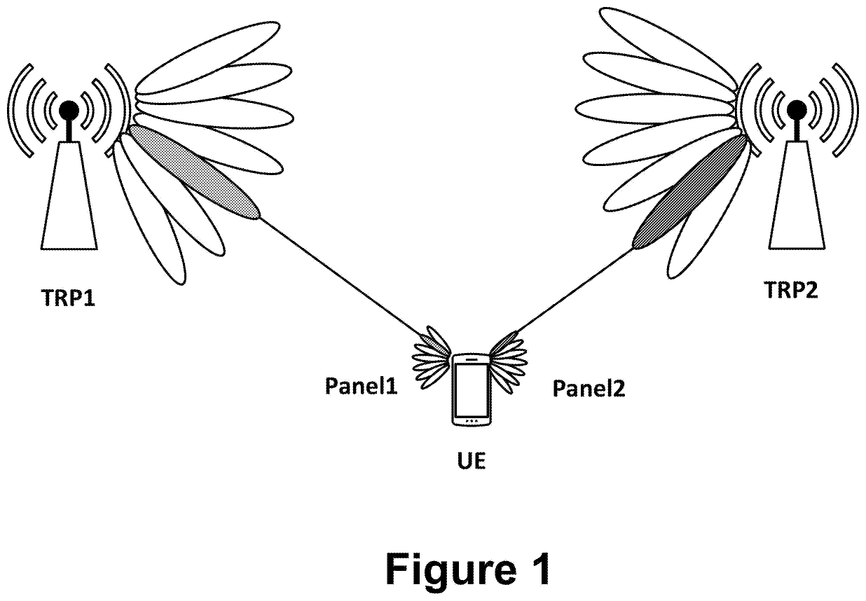

When UE is equipped with more than one panel, multiple Tx beams can be formed at the same time. In this case, UE may transmit two PUSCHs or PUCCHs by using two Tx beams simultaneously. The multiple Tx beams may reduce the latency for uplink transmission and/or improve the reliability. FIG. 1 illustrates one example of multi-TRP multi-panel operation for uplink transmission. In the example, Tx beam from panel 1 is targeted for TRP1 while Tx beam from panel 2 is targeted for TRP2.

Note that UCI can be carried by PUCCH or PUSCH. The UCI may include, for example, a scheduling request (SR), hybrid automatic repeat request-acknowledgement (HARQ-ACK) feedback, a channel state information (CSI) report (e.g., channel quality indicator (CQI), pre-coding matrix indicator (PMI), CSI resource indicator (CRI), and/or rank indicator (RI)) and/or beam related information (e.g., layer 1-reference signal received power (L1-RSRP)).

Various embodiments herein provide mechanisms for UCI multiplexing in multi-TRP multi-panel operation. For example, embodiments may provide mechanisms for selection of the PUSCH for UCI multiplexing in case of multi-TRP multi-panel operation, when two PUSCH transmissions using two panels overlap with one PUCCH transmission using one panel in time domain. The embodiments may avoid misunderstanding between the gNB and UE to ensure reliable communication.

As mentioned above, when UE is equipped with more than one panel, multiple Tx beams can be formed at the same time. In this case, UE may transmit two PUSCHs or PUCCHs by using two Tx beams simultaneously, which can reduce the latency for uplink transmission while improving the reliability.

In case of multi-TRP multi-panel operation, when two PUSCH transmissions using two panels overlap with one PUCCH transmission using one panel in time domain, certain mechanisms may need to be defined for the selection of PUSCH for UCI multiplexing, in order to avoid misunderstanding between the gNB and the UE.

In the following embodiments, the terminology “targeted for the same TRP” may correspond to being “associated with a same TRP index” or “associated with a same panel index”.

Aspects of various embodiments of UCI multiplexing for multi-TRP multi-panel operation are described further below.

In one embodiment, indication of TRP index or panel index may be explicitly indicated in the downlink control information (DCI) for scheduling. Note that for this option, panel index and association between panel and TRP index may be defined and configured by the higher layers.

Table 1 illustrates one example of explicit indication of panel index in the DCI for scheduling PUSCH transmission. In the example, dynamic switching between single panel and multi-panel operation is enabled.

TABLE 1
Explicit indication of panel index in the DCI

| Bit field in the DCI | Indication of panel index |
|---|---|
| 00 | Panel #0 |
| 01 | Panel #1 |
| 10 | Panel #0 and #1 |
| 11 | Reserved |

In another option, TRP index or panel index for multi-TRP multi-panel operation may be associated with a control resource set (CORESET) pool index, coresetPoolIndex in ControlResourceSets. Table 2 illustrates one example of explicit indication of coresetPoolIndex in the DCI.

TABLE 2
Explicit indication of coresetPoolIndex in the DCI

| Bit field in the DCI | Indication of panel or TRP index |
|---|---|
| 00 | coresetPoolIndex = 0 |
| 01 | coresetPoolIndex = 1 |
| 10 | coresetPoolIndex = 0 and 1 |
| 11 | Reserved |

In another option, for multi-DCI (mDCI) based scheduling (e.g., when multiple DCIs are used to schedule the respective uplink transmissions), one-bit field in the DCI may be used to indicate whether same or different coresetPoolIndex as the CORESET for scheduling DCI is used for PUSCH and/or PUCCH transmission. Table 3 illustrates one example of indication of panel or TRP index for this option.

TABLE 3
Indication of panel or TRP index

| Bit field in the DCI | Indication of panel or TRP index |
|---|---|
| 0 | Same coresetPoolIndex as the |
| | CORESET for scheduling DCI |
| 1 | Different coresetPoolIndex from |
| | the CORESET for scheduling DCI |

Note that for the above options, the explicit indication of TRP or panel index for multi-TRP multi-panel operation may be included in the DCI format 0_1, 1_2, 1_1 and 1_2.

In another embodiment, for configured grant PUSCH, panel index, or TRP index or associated coresetPoolIndex can be configured as part of ConfiguredGrantConfig configuration.

In another embodiment, for PUCCH without associated PDCCH, e.g., PUCCH carrying semi-persistent scheduling (SPS) HARQ-ACK feedback, SR, periodic CSI (P-CSI) and semi-persistent (SP)-CSI report, panel index, or TRP index or associated coresetPoolIndex can be configured.

In one option, panel index, or TRP index or associated coresetPool Index can be configured as part of PUCCH resource configuration. Alternatively, panel index, or TRP index or associated coresetPoolIndex can be configured as part of PUCCH resource set configuration.

In one embodiment, for multi-TRP multi-panel operation, when a group of PUSCHs and/or PUCCHs targeted for different TRPs overlap in time, and if the timeline requirement as defined in Section 9.2.5 in 3GPP TS38.213 [1] is satisfied, UCI multiplexing or PUCCH/PUSCH cancellation is performed on PUSCH and/or PUCCH for the same TRP based on existing mechanism as defined in Rel-15/16/17.

This may apply for the case when a single-DCI (sDCI) or multi-DCI (mDCI) is used to schedule PUSCH and/or PUCCH transmission for different TRPs. Further, UE can transmit multiple PUSCHs and/or PUCCHs simultaneously using more than one panels.

In one option, when two PUSCHs for two TRPs overlap with PUCCH for one TRP, if the timeline requirement as defined in Section 9.2.5 in TS38.213 [1] is satisfied, UCI is multiplexed on the PUSCH for the same TRP, and the PUCCH is dropped.

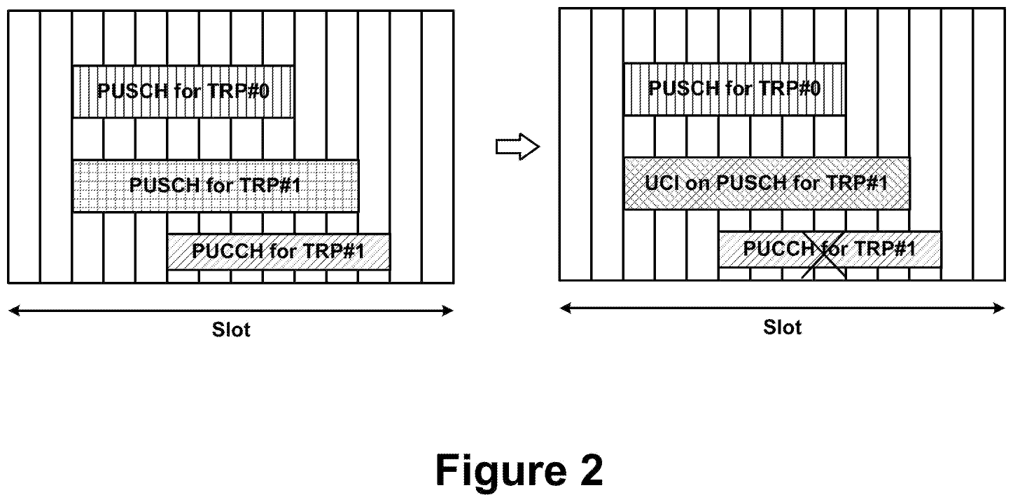

FIG. 2 illustrates one example of UCI multiplexing on PUSCH for multi-TRP multi-panel operation. In the example, PUCCH for TRP #1 overlaps with PUSCH transmissions for TRP #0 and #1 in time domain. Based on this option, PUCCH for TRP #1 is dropped and UCI is multiplexed on the PUSCH for the TRP #1.

Note that although in the figure, different time domain resource allocations are applied for PUSCH transmissions for two TRPs, the embodiments can be extended and applied for the case when same time domain resource allocation is applied for two PUSCH transmissions.

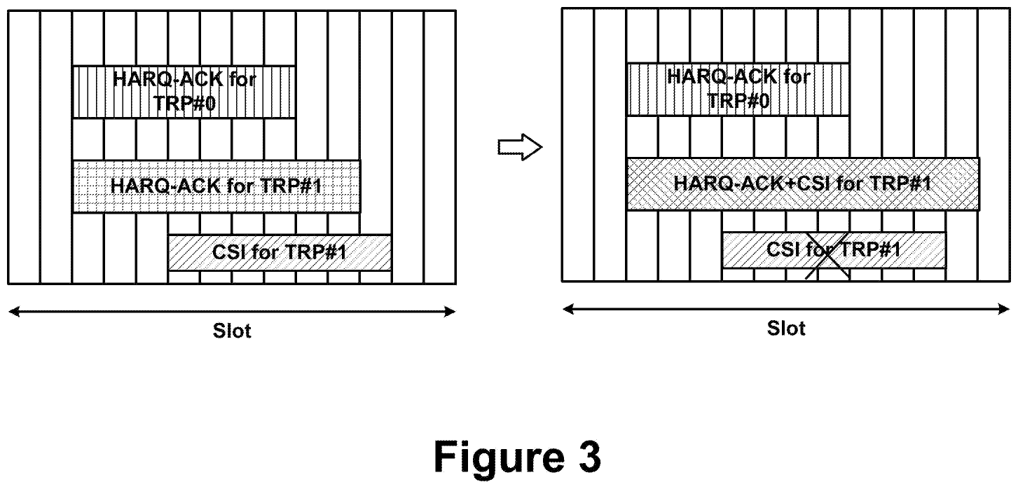

FIG. 3 illustrates one example of UCI multiplexing on PUCCH for multi-TRP multi-panel operations. In the example, PUCCH carrying CSI report for TRP #1 overlaps with PUCCH transmissions carrying HARQ-ACK feedback for TRP #0 and #1 in time domain. Based on this option, PUCCH carrying CSI report for TRP #1 is dropped and HARQ-ACK and CSI report are multiplexed on the PUCCH for the TRP #1.

As a further extension, after the collision handling for the group of PUSCHs and/or PUCCH for more than one TRPs is performed, UE may not expect that PUSCH for one TRP overlaps with PUCCH for another TRP overlap in time.

In another embodiment, for multi-TRP multi-panel operation, when a group of PUSCHs and/or PUCCHs targeted for different TRPs overlap in time, and if the timeline requirement as defined in Section 9.2.5 in TS38.213 [1] is satisfied, UCI multiplexing or PUCCH/PUSCH cancellation is performed on PUSCH and/or PUCCH for all the TRPs based on existing mechanism as defined in Rel-15/16/17.

This may apply for the case when PUCCH carrying UCI targeted for more than one TRPs. In one option, when two PUSCHs for two TRPs overlap with PUCCH for one TRP, if the timeline requirement as defined in Section 9.2.5 in TS38.213 [1] is satisfied, UCI is multiplexed on the PUSCH for both TRPs, and the PUCCH is dropped.

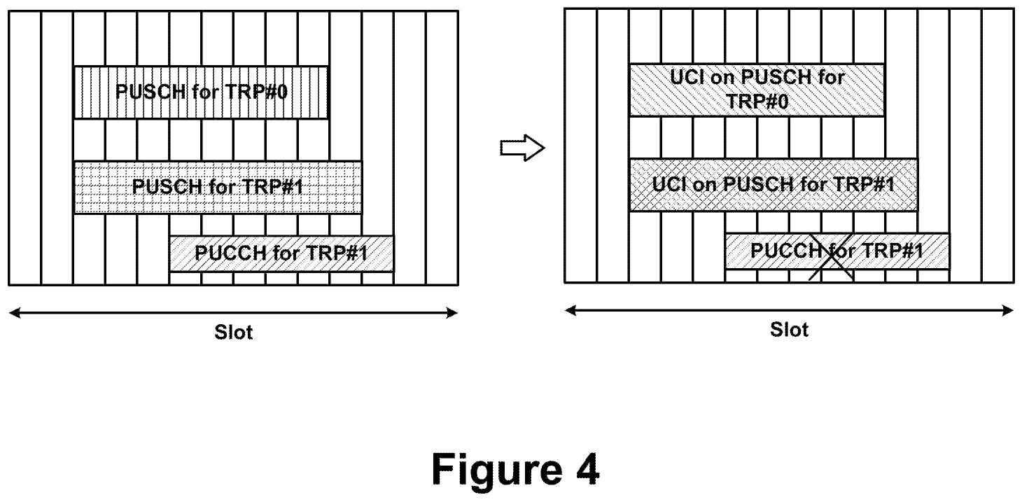

FIG. 4 illustrates one example of UCI multiplexing on PUSCH for multi-TRP multi-panel operations. In the example, PUCCH for TRP #1 overlaps with PUSCH transmissions for TRP #0 and #1 in time domain. Based on this option, PUCCH for TRP #1 is dropped and UCI is multiplexed on the PUSCH for both TRP #0 and TRP #1.

In another embodiment, for multi-TRP multi-panel operation, when a group of PUSCHs and/or PUCCHs targeted for different TRPs overlap in time, and if the timeline requirement as defined in Section 9.2.5 in TS38.213 [1] is satisfied, UCI multiplexing or PUCCH/PUSCH cancellation is performed on PUSCH and/or PUCCH on the TRP with lowest index based on existing mechanism as defined in Rel-15/16/17.

Handling Collision Between PUSCH and PUCCH with Different Priorities

Aspects of various embodiments for handling collision between PUSCH and PUCCH with different priorities are described further below.

In one embodiment, for multi-TRP multi-panel operation, if the timeline requirement as defined in Section 9.2.5 in TS38.213 [1] is satisfied, the following procedure can be used to handle overlapping PUCCHs/PUSCHs with different priorities,
Step 1: resolve overlapping PUCCHs and/or PUSCHs with same priority for the same TRP
Step 2: resolve overlapping PUCCHs and/or PUSCH with different priorities for the same TRP:
Step 3: if the resulting PUCCHs and/or PUSCHs with different TRPs have different priorities and if they overlap in time, the resulting PUCCHs and/or PUSCHs with low priority are cancelled or dropped. If the resulting PUCCHs and/or PUSCHs with different TRPs have same priority, UE may transmit the resulting PUCCHs and/or PUSCH for different TRPs simultaneously.

Note that the Step 3 may depend on UE capability. If a UE is capable of transmitting PUSCH and/or PUCCH with different priorities using more than one panels simultaneously, the step 3 may be omitted.

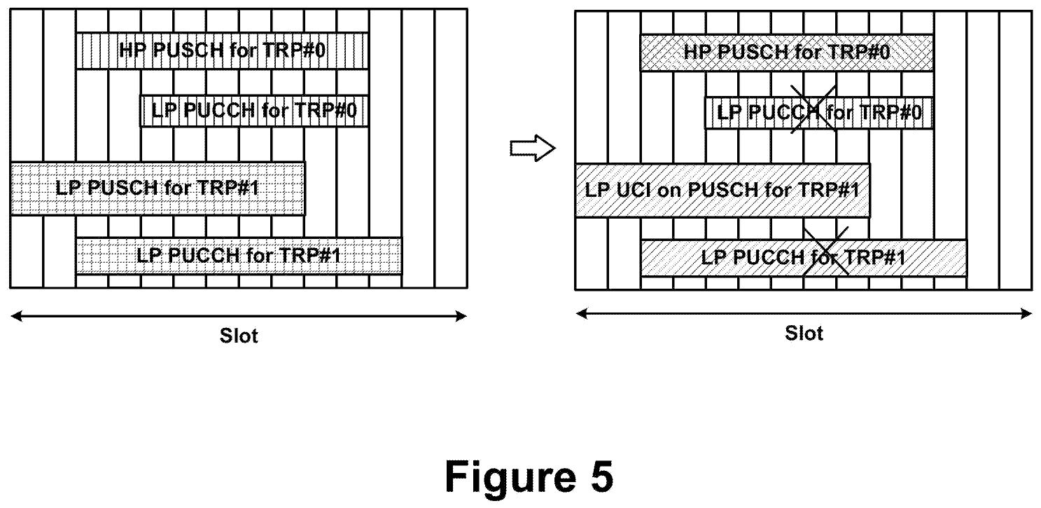

FIG. 5 illustrates one example of UCI multiplexing with different priorities. In the example, in the first two steps, for PUSCH and PUCCH for TRP #0, low priority (LP) PUCCH is cancelled and high priority (HP) PUSCH is determined for the subsequent step. For PUSCH and PUCCH for TRP #1, as LP PUCCH overlaps with LP PUCCH in time, UCI is multiplexed on PUSCH for TRP #1. If UE is capable of transmitting PUSCH with different priorities using two panels, both HP PUSCH for TRP #0 and LP UCI on PUSCH for TRP #1 are transmitted.

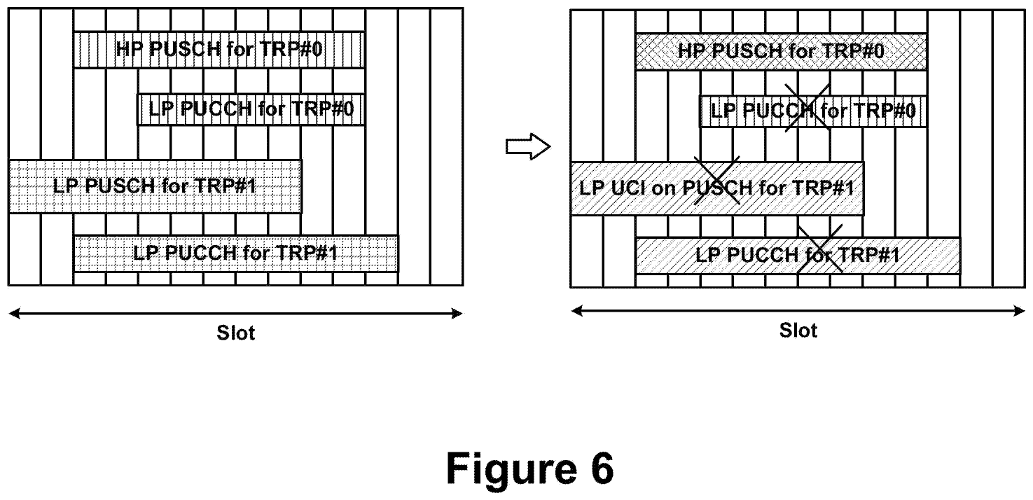

FIG. 6 illustrates one example of UCI multiplexing with different priorities. In the example, in the first two steps, for PUSCH and PUCCH for TRP #0, low priority (LP) PUCCH is cancelled and high priority (HP) PUSCH is determined for the subsequent step. For PUSCH and PUCCH for TRP #1, as LP PUCCH overlaps with LP PUCCH in time, UCI is multiplexed on PUSCH for TRP #1. As the resulting HP PUSCH for TRP #0 and LP UCI on PUSCH for TRP #1 overlap in time, LP UCI on PUSCH for TRP #1 is cancelled and UE transmits the HP PUSCH for TRP #0.

In another embodiment, for multi-TRP multi-panel operation, if the timeline requirement as defined in Section 9.2.5 in TS38.213 [1] is satisfied, the following procedure can be used to handle overlapping PUCCHs/PUSCHs with different priorities:
Step 1: resolve overlapping PUCCHs and/or PUSCHs with same priority for the same TRP
Step 2: resolve overlapping PUCCHs and/or PUSCH with different priorities, regardless of TRP index.

In another embodiment, for multi-TRP multi-panel operation, if the timeline requirement as defined in Section 9.2.5 in TS38.213 [1] is satisfied, the following procedure can be used to handle overlapping PUCCHs/PUSCHs with different priorities:
Step 1: resolve overlapping PUCCHs and/or PUSCHs with same priority for all the TRPs
Step 2: resolve overlapping PUCCHs and/or PUSCH with different priorities for all the TRPs.

### Timing Control for Multi-TRP Multi-Panel Operation

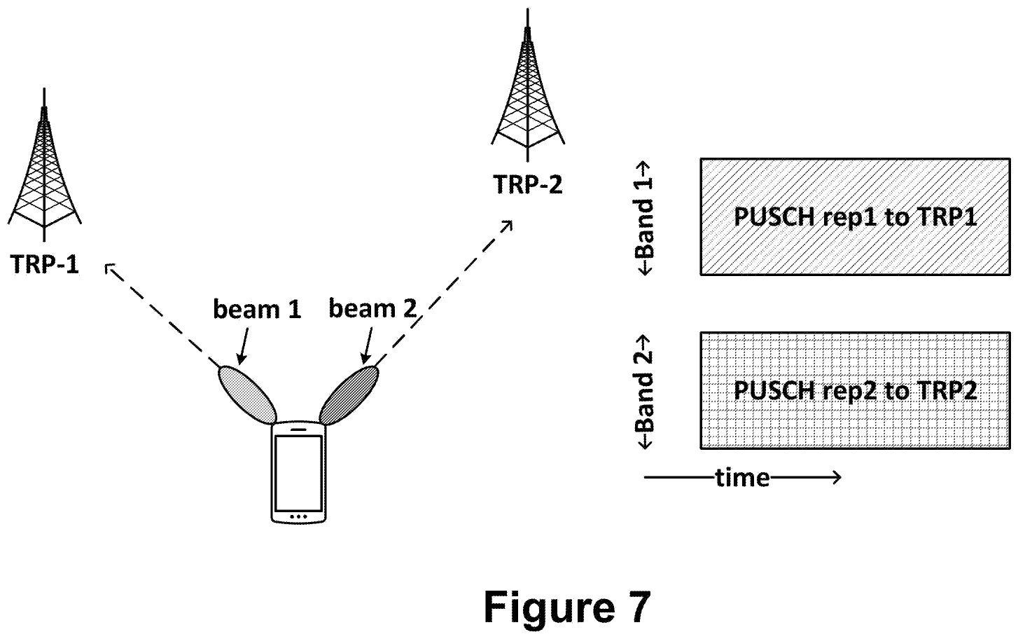

3GPP Rel-17 NR supports multi-TRP PUSCH/PUCCH repetitions/transmissions, which means the same uplink (UL) data or control information can be transmitted to multiple TRPs as multiple repetitions/transmissions in multiple time slots or sub-slots. However, in each time slot or sub-slot, there can be only one UL transmission occasion towards a certain TRP. To utilize the multiple TRPs more efficiently, Rel-18 5G NR system may support simultaneous multi-TRP (transmission reception point) transmission schemes in UL. In particular, to increase the overall capacity and to increase robustness of the transmission to potential blockage of the channel, UE could transmit signal targeting two or more TRPs simultaneously as shown in FIG. 7.

To support simultaneous multi-TRP transmission schemes in UL, different transmission schemes can be considered. For example, the mTRP transmissions can be scheduled by either a single DCI (sDCI) or multiple DCIs (mDCI), the mTRP transmission occasions can be multiplexed in time/frequency/spatial domain, the resource allocation for mTRP transmission can be different, etc.

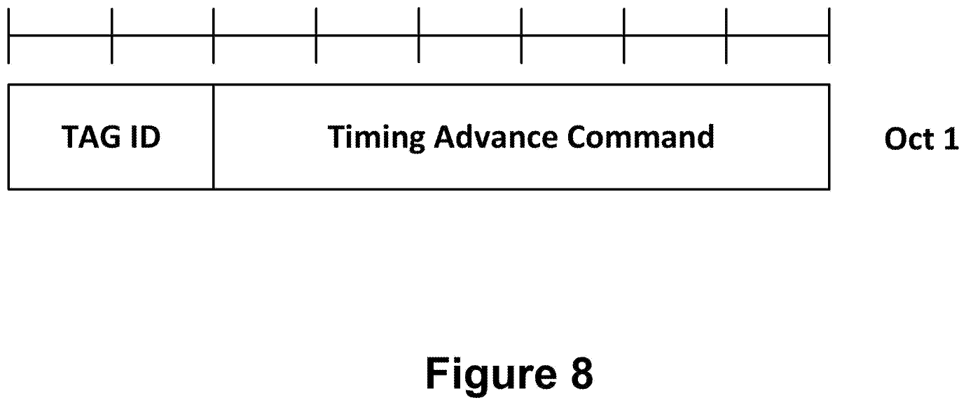

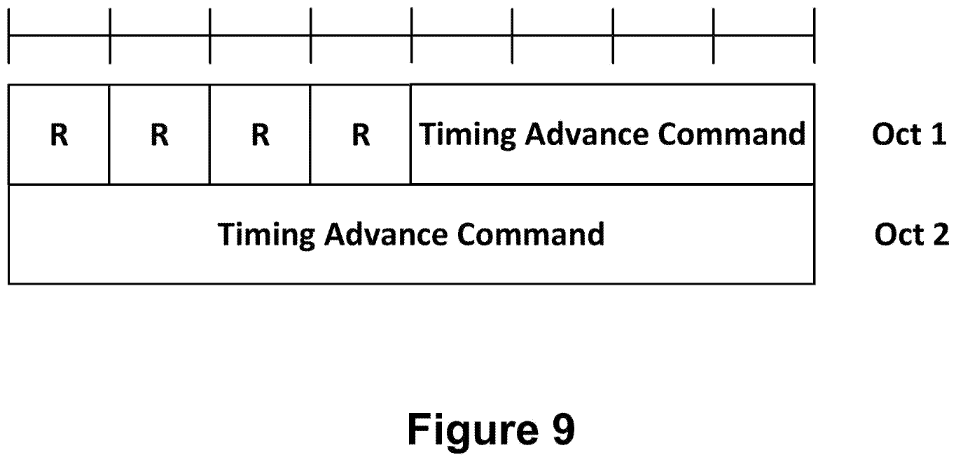

In NR, timing advance is a command sent by the Base Station (BS, e.g., next generation Node B (gNB)) to a UE to adjust the UL (e.g., PUSCH, PUCCH, sounding reference signal (SRS)) transmission timing. For example, the BS measures the time difference between the reception of PUSCH/PUCCH/SRS and the local subframe timing so that it knows how whether the PUSCH/PUCCH/SRS arrives to the BS too early or too late. Then, a timing advance command (TAC) is sent from the BS to the UE. The UE should adjust its UL transmission according to the TAC value to make the UL transmission to be aligned with the BS's subframe timing. For example, if the TAC value is positive, the UE should transmit earlier, else if the TAC value is negative, the UE should transmit later. A TAC can be transmitted in case of random access response or in an absolute timing advance command MAC CE. In 3GPP TS38.321, v. 17.0.0, 17 Mar. 2022, there are 2 timing advance MAC CEs with different length, shown in FIG. 8 and FIG. 9, respectively.

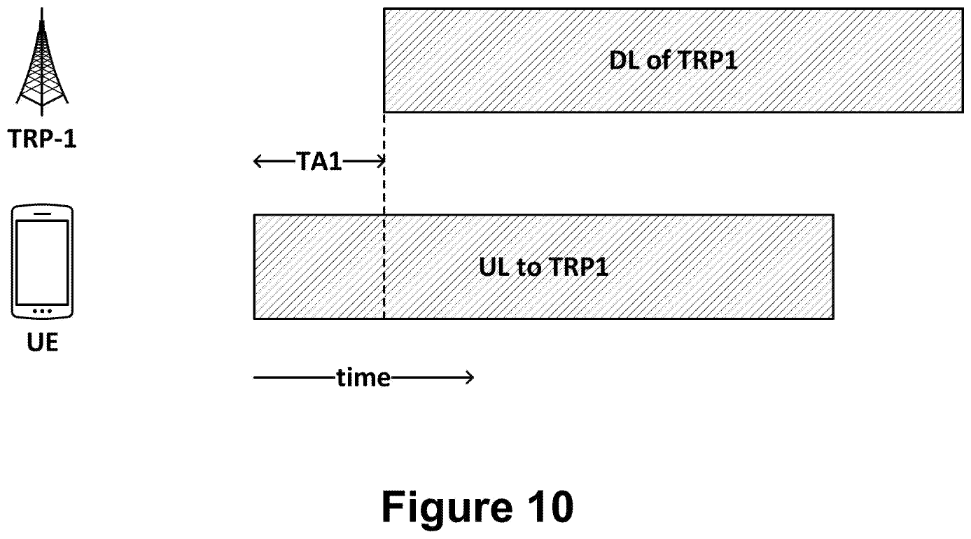

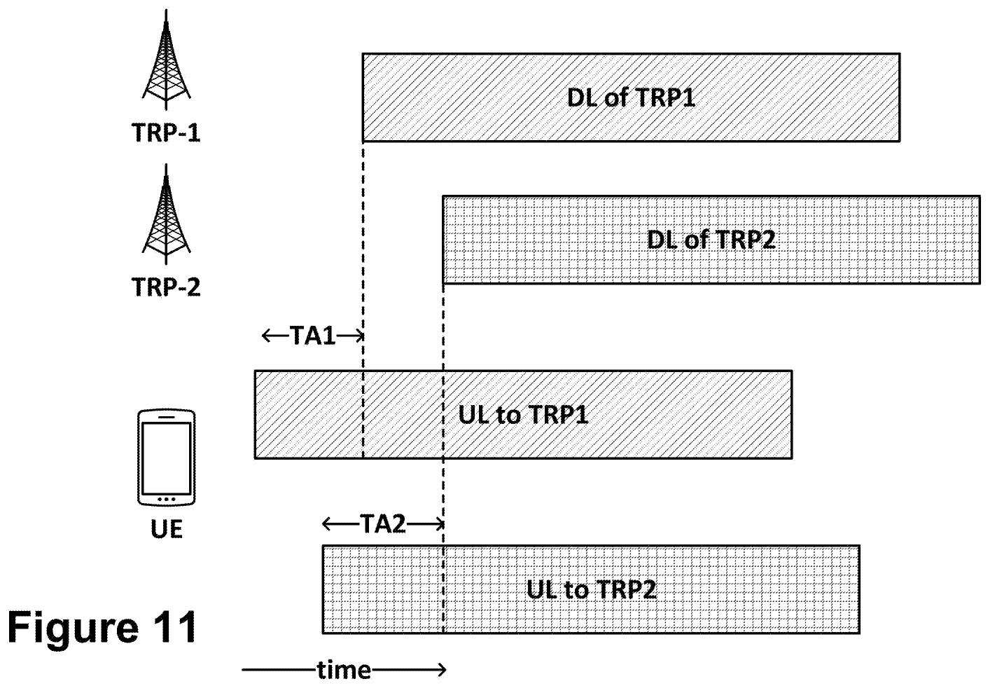

In the current NR system, timing advance adaption is only preformed in single UL transmission scenarios, using a MAC CE containing a single TAC. However, release 18 (Rel-18) NR is going to support simultaneous UL transmission, which may need two TACs. It needs to be resolved how to compute and indicate the two TACs. For example, in single-TRP scenario as shown in FIG. 10, one TAC computed according to one reference TRP is enough. However, in a multi-TRP scenario as shown in FIG. 11, one TAC computed according to one reference TRP is not enough.

As explained above, the existing timing advance process is only for non-simultaneous UL transmission. Timing advance for simultaneous UL transmission does not exist. Embodiments herein address these and other issues by computing and indicating TAC(s) in multi-TRP simultaneous UL transmission operation.

As mentioned above, in multi-TRP operation, multiple timing advance commands are needed to indicate different TAC values. For example, in one slot, the timing difference between the UL transmission to TRP1 and the local subframe timing at TRP1 is TA1, while the timing difference between the UL transmission to TRP2 and the local subframe timing at TRP2 is TA2, as shown in FIG. 11. TA1 and TA2 can be computed with different reference signals to make the reception of UL transmission at TRP1 and TRP2 are aligned with the local subframe timing. Thus, separate timing advance should be maintained among the TRPs.

In one embodiment for a multi-TRP timing advance issue, the network (NW) and the UE can use two reference timings for TRP−1 and TRP−2 respectively. For example, the NW measures two TA values, TA1 and TA2, for TRP1 and TRP2, respectively. And indicated the TAC via the MAC CE shown in FIG. 9, where one of the reserved field R can be used to distinguish TRP1 and TRP2, e.g., R=0 corresponds to TRP1 and R=1 corresponds to TRP2, or R=1 corresponds to TRP1 and R=0 corresponds to TRP2.

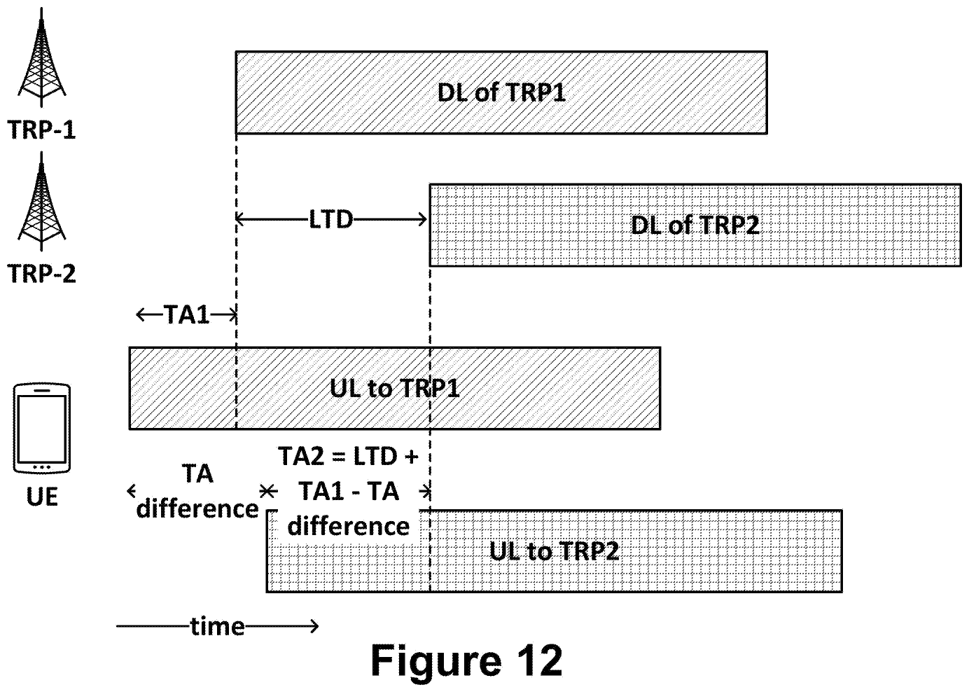

In another embodiment for a multi-TRP timing advance issue, the NW and UE can maintain one reference timing advance for a certain TRP (e.g., TA1), one timing advance difference between UL reception timing difference between the UL to TRP1 and UL to TRP2, and one local timing difference (LTD), as shown in FIG. 12. The value of TA2 can be computed as TA2=LTD+TA1−TA difference. Since the UE does not need to know the LTD, only TA1 and TA difference need to be indicated to the UE. In some embodiments, the TA difference is not updated until a new TA difference is indicated or a reference TA is changed.

The computation of TA difference can be either periodic or aperiodic at the gNB. By controlling the indicating periodicity of the TA difference or the triggering condition of aperiodic TA difference, the NW can increase the timing accuracy between the DL and UL or reduce the overhead of TAC in multi-TRP operation.

The indication of TA difference can use the MAC CE shown in FIG. 9, where a reserved field can be used to indicate it is a MAC CE for TA difference. For example, the first reserved field can be used to indicate if it is a normal TA for TA1 or TA2. The second reserved field can be used to indicate whether it is TA offset or not.

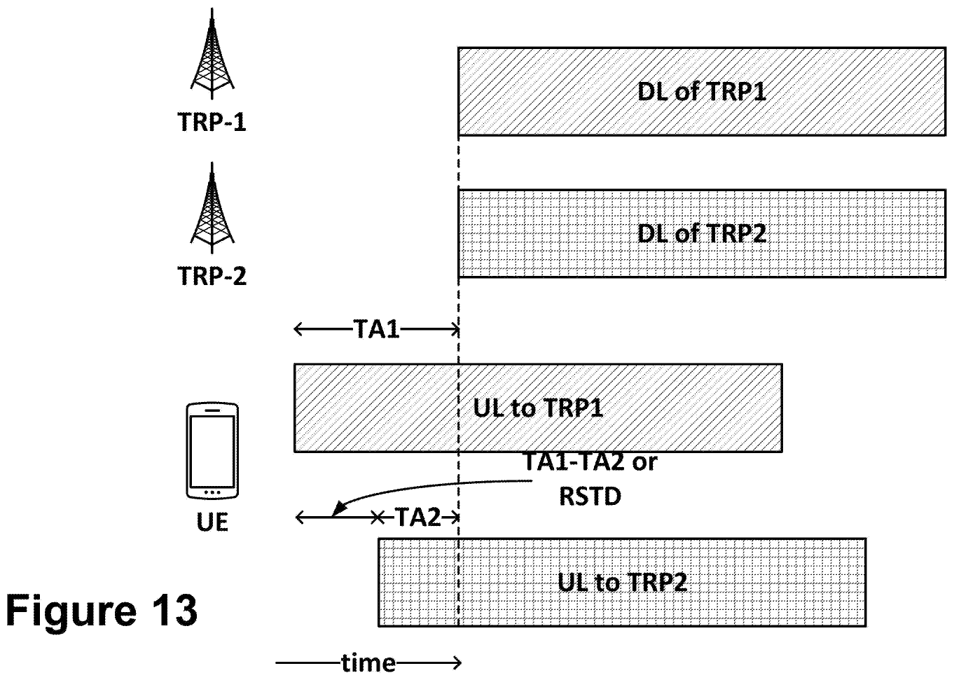

In another embodiment for a multi-TRP timing advance issue, if TRP1 and TRP2 are perfectly synchronized as shown in FIG. 13, the UE can measure the DL reception time difference between two DL signals, e.g., SSB blocks. And because of the reciprocity, the reception time difference of the UL transmission at TRP1 and TRP2 is the same as DL. In other words, the value of TA1−TA2 can be estimated by measuring the DL reception time difference between two DL signals. Thus, in this case, only one TA is needed to be indicated by the gNB. The TA can be transmitted through MAC CE shown in FIG. 9, where a reserved field can be used to indicate whether the TA value is for TRP1 or TRP2, e.g., R=0 corresponds to TRP1 and R=1 corresponds to TRP2, or R=1 corresponds to TRP1 and R=0 corresponds to TRP2. In one instance, a reference signal time difference (RSTD) between TRP−1 and TRP−2 is measured and reported by the UE to the gNB. In one instance, a DL RS (for e.g. CSI-RS or SSB) is associated with a TRP-index (e.g. CORESETPoolIndex or a PCID)-a UE is configured with a CSI-RS from each TRP (e.g. each CSI-RS configured with CORESETPoolIndex 0 or 1) and the UE reports RSTD assuming a reference TRP (e.g. TRP with CORESETPoolIndex=0)

In another embodiment for a multi-TRP timing advance issue, the UE and the gNB needs a common understanding of the association between the two TRPs and the two TAs. This can be done with RRC, MAC CE, or DCI indication. For example, TA1 and TA2 can be linked to the reference signals that are associated with TRP1 and TRP2 respectively. For instance, TA1 can be associated with a several SRS resources or TCI states, TA2 can be associated with other SRS resources or TCI states. In one instance, application of TA1 and TA2 can be associated with uplink transmission associated with CORESETPool Index values 0 and 1−TA1 is applied to an uplink transmission (PUSCH, PUCCH, SRS) scheduled from a PDCCH associated with CORESETPoolIndex=0 while TA2 is applied to an uplink transmission (PUSCH, PUCCH, SRS) scheduled from a PDCCH associated with CORESETPoolIndex=1. In one instance, uplink transmission that is not associated with a PDCCH (for example, periodic PUCCH, SRS or configured grant PUSCH) is associated with a reference TA called TA1. In another instance, a PUCCH resource or a SRS resource or a configured grant is associated with a TRP-index taking values 0 or 1. As an example this TRP index is CORESETPoolIndex. In another instance, by default or if associated with a configured TRP-index=0 an uplink transmission is associated with a reference TA called TA1 while if a certain uplink resource/channel is associated with a configured TRP-index=1 then it is transmitted with a TA called TA2 (different from reference TA)

In one embodiment, a UE receives an initial TA1 and an initial TA2 corresponding to TRP−1 and TRP−2 and receives further adjustments based on the initial values which are given by TA1 and TA2 values respectively. The distinction between initial and further adjustments is indicated by the gNB to the UE (for e.g. by a distinction in the MAC-CE content).

In one embodiment, a UE reports an initial RSTD corresponding to TRP−1 and TRP−2 and reports further adjustments based on the initial RSTD value. The distinction between initial and further adjustments is indicated by the UE to the gNB (for e.g. by a distinction in the UE report content).

### Systems and Implementations

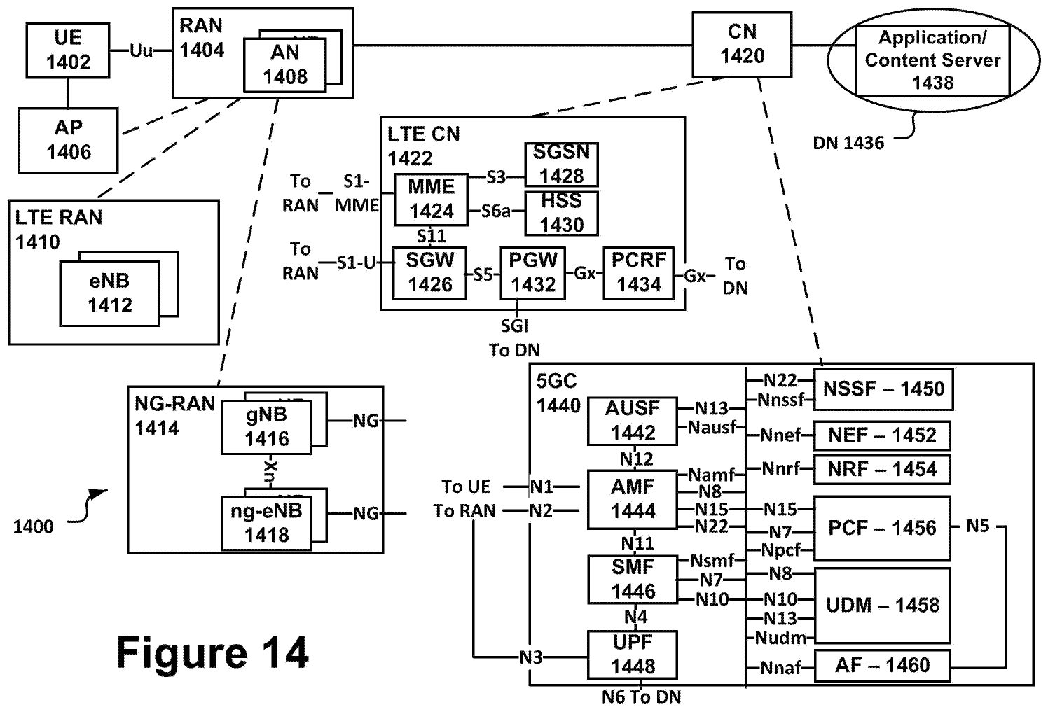

FIGS. 14-16 illustrate various systems, devices, and components that may implement aspects of disclosed embodiments.

FIG. 14 illustrates a network 1400 in accordance with various embodiments. The network 1400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1400 may include a UE 1402, which may include any mobile or non-mobile computing device designed to communicate with a RAN 1404 via an over-the-air connection. The UE 1402 may be communicatively coupled with the RAN 1404 by a Uu interface. The UE 1402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1402 may additionally communicate with an AP 1406 via an over-the-air connection. The AP 1406 may manage a WLAN connection, which may serve to offload some/all network traffic from the RAN 1404. The connection between the UE 1402 and the AP 1406 may be consistent with any IEEE 802.11 protocol, wherein the AP 1406 could be a wireless fidelity (Wi-Fi®) router. In some embodiments, the UE 1402, RAN 1404, and AP 1406 may utilize cellular-WLAN aggregation (for example, LWA/LWIP). Cellular-WLAN aggregation may involve the UE 1402 being configured by the RAN 1404 to utilize both cellular radio resources and WLAN resources.

The RAN 1404 may include one or more access nodes, for example, AN 1408. AN 1408 may terminate air-interface protocols for the UE 1402 by providing access stratum protocols including RRC, PDCP, RLC, MAC, and L1 protocols. In this manner, the AN 1408 may enable data/voice connectivity between CN 1420 and the UE 1402. In some embodiments, the AN 1408 may be implemented in a discrete device or as one or more software entities running on server computers as part of, for example, a virtual network, which may be referred to as a CRAN or virtual baseband unit pool. The AN 1408 be referred to as a BS, gNB, RAN node, eNB, ng-eNB, NodeB, RSU, TRxP, TRP, etc. The AN 1408 may be a macrocell base station or a low power base station for providing femtocells, picocells or other like cells having smaller coverage areas, smaller user capacity, or higher bandwidth compared to macrocells.

In embodiments in which the RAN 1404 includes a plurality of ANs, they may be coupled with one another via an X2 interface (if the RAN 1404 is an LTE RAN) or an Xn interface (if the RAN 1404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1404 may each manage one or more cells, cell groups, component carriers, etc. to provide the UE 1402 with an air interface for network access. The UE 1402 may be simultaneously connected with a plurality of cells provided by the same or different ANs of the RAN 1404. For example, the UE 1402 and RAN 1404 may use carrier aggregation to allow the UE 1402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1402 or AN 1408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1404 may be an LTE RAN 1410 with eNBs, for example, eNB 1412. The LTE RAN 1410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1404 may be an NG-RAN 1414 with gNBs, for example, gNB 1416, or ng-eNBs, for example, ng-eNB 1418. The gNB 1416 may connect with 5G-enabled UEs using a 5G NR interface. The gNB 1416 may connect with a 5G core through an NG interface, which may include an N2 interface or an N3 interface. The ng-eNB 1418 may also connect with the 5G core through an NG interface, but may connect with a UE via an LTE air interface. The gNB 1416 and the ng-eNB 1418 may connect with each other over an Xn interface.

In some embodiments, the NG interface may be split into two parts, an NG user plane (NG-U) interface, which carries traffic data between the nodes of the NG-RAN 1414 and a UPF 1448 (e.g., N3 interface), and an NG control plane (NG-C) interface, which is a signaling interface between the nodes of the NG-RAN1414 and an AMF 1444 (e.g., N2 interface).

The NG-RAN 1414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1402 can be configured with multiple BWPs where each BWP configuration has a different SCS. When a BWP change is indicated to the UE 1402, the SCS of the transmission is changed as well. Another use case example of BWP is related to power saving. In particular, multiple BWPs can be configured for the UE 1402 with different amount of frequency resources (for example, PRBs) to support data transmission under different traffic loading scenarios. A BWP containing a smaller number of PRBs can be used for data transmission with small traffic load while allowing power saving at the UE 1402 and in some cases at the gNB 1416. A BWP containing a larger number of PRBs can be used for scenarios with higher traffic load.

The RAN 1404 is communicatively coupled to CN 1420 that includes network elements to provide various functions to support data and telecommunications services to customers/subscribers (for example, users of UE 1402). The components of the CN 1420 may be implemented in one physical node or separate physical nodes. In some embodiments, NFV may be utilized to virtualize any or all of the functions provided by the network elements of the CN 1420 onto physical compute/storage resources in servers, switches, etc. A logical instantiation of the CN 1420 may be referred to as a network slice, and a logical instantiation of a portion of the CN 1420 may be referred to as a network sub-slice.

In some embodiments, the CN 1420 may be an LTE CN 1422, which may also be referred to as an EPC. The LTE CN 1422 may include MME 1424, SGW 1426, SGSN 1428, HSS 1430, PGW 1432, and PCRF 1434 coupled with one another over interfaces (or “reference points”) as shown. Functions of the elements of the LTE CN 1422 may be briefly introduced as follows.

The MME 1424 may implement mobility management functions to track a current location of the UE 1402 to facilitate paging, bearer activation/deactivation, handovers, gateway selection, authentication, etc.

The SGW 1426 may terminate an SI interface toward the RAN and route data packets between the RAN and the LTE CN 1422. The SGW 1426 may be a local mobility anchor point for inter-RAN node handovers and also may provide an anchor for inter-3GPP mobility. Other responsibilities may include lawful intercept, charging, and some policy enforcement. The SGSN 1428 may track a location of the UE 1402 and perform security functions and access control. In addition, the SGSN 1428 may perform inter-EPC node signaling for mobility between different RAT networks; PDN and S-GW selection as specified by MME 1424; MME selection for handovers; etc. The S3 reference point between the MME 1424 and the SGSN 1428 may enable user and bearer information exchange for inter-3GPP access network mobility in idle/active states.

The HSS 1430 may include a database for network users, including subscription-related information to support the network entities' handling of communication sessions. The HSS 1430 can provide support for routing/roaming, authentication, authorization, naming/addressing resolution, location dependencies, etc. An S6a reference point between the HSS 1430 and the MME 1424 may enable transfer of subscription and authentication data for authenticating/authorizing user access to the LTE CN 1420.

The PGW 1432 may terminate an SGi interface toward a data network (DN) 1436 that may include an application/content server 1438. The PGW 1432 may route data packets between the LTE CN 1422 and the data network 1436. The PGW 1432 may be coupled with the SGW 1426 by an S5 reference point to facilitate user plane tunneling and tunnel management. The PGW 1432 may further include a node for policy enforcement and charging data collection (for example, PCEF). Additionally, the SGi reference point between the PGW 1432 and the data network 14 36 may be an operator external public, a private PDN, or an intra-operator packet data network, for example, for provision of IMS services. The PGW 1432 may be coupled with a PCRF 1434 via a Gx reference point.

The PCRF 1434 is the policy and charging control element of the LTE CN 1422. The PCRF 1434 may be communicatively coupled to the app/content server 1438 to determine appropriate QoS and charging parameters for service flows. The PCRF 1432 may provision associated rules into a PCEF (via Gx reference point) with appropriate TFT and QCI.

In some embodiments, the CN 1420 may be a 5GC 1440. The 5GC 1440 may include an AUSF 1442, AMF 1444, SMF 1446, UPF 1448, NSSF 1450, NEF 1452, NRF 1454, PCF 1456, UDM 1458, and AF 1460 coupled with one another over interfaces (or “reference points”) as shown. Functions of the elements of the 5GC 1440 may be briefly introduced as follows.

The AUSF 1442 may store data for authentication of UE 1402 and handle authentication-related functionality. The AUSF 1442 may facilitate a common authentication framework for various access types. In addition to communicating with other elements of the 5GC 1440 over reference points as shown, the AUSF 1442 may exhibit an Nausf service-based interface.

The AMF 1444 may allow other functions of the 5GC 1440 to communicate with the UE 1402 and the RAN 1404 and to subscribe to notifications about mobility events with respect to the UE 1402. The AMF 1444 may be responsible for registration management (for example, for registering UE 1402), connection management, reachability management, mobility management, lawful interception of AMF-related events, and access authentication and authorization. The AMF 1444 may provide transport for SM messages between the UE 1402 and the SMF 1446, and act as a transparent proxy for routing SM messages. AMF 1444 may also provide transport for SMS messages between UE 1402 and an SMSF. AMF 1444 may interact with the AUSF 1442 and the UE 1402 to perform various security anchor and context management functions. Furthermore, AMF 1444 may be a termination point of a RAN CP interface, which may include or be an N2 reference point between the RAN 1404 and the AMF 1444; and the AMF 1444 may be a termination point of NAS (N1) signaling, and perform NAS ciphering and integrity protection. AMF 1444 may also support NAS signaling with the UE 1402 over an N3 IWF interface.

The SMF 1446 may be responsible for SM (for example, session establishment, tunnel management between UPF 1448 and AN 1408); UE IP address allocation and management (including optional authorization); selection and control of UP function; configuring traffic steering at UPF 1448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1444 over N2 to AN 1408; and determining SSC mode of a session. SM may refer to management of a PDU session, and a PDU session or “session” may refer to a PDU connectivity service that provides or enables the exchange of PDUs between the UE 1402 and the data network 1436.

The UPF 1448 may act as an anchor point for intra-RAT and inter-RAT mobility, an external PDU session point of interconnect to data network 1436, and a branching point to support multi-homed PDU session. The UPF 1448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1448 may include an uplink classifier to support routing traffic flows to a data network.

The NSSF 1450 may select a set of network slice instances serving the UE 1402. The NSSF 1450 may also determine allowed NSSAI and the mapping to the subscribed S-NSSAIs, if needed. The NSSF 1450 may also determine the AMF set to be used to serve the UE 1402, or a list of candidate AMFs based on a suitable configuration and possibly by querying the NRF 1454. The selection of a set of network slice instances for the UE 1402 may be triggered by the AMF 1444 with which the UE 1402 is registered by interacting with the NSSF 1450, which may lead to a change of AMF. The NSSF 1450 may interact with the AMF 1444 via an N22 reference point; and may communicate with another NSSF in a visited network via an N31 reference point (not shown). Additionally, the NSSF 1450 may exhibit an Nnssf service-based interface.

The NEF 1452 may securely expose services and capabilities provided by 3GPP network functions for third party, internal exposure/re-exposure, AFs (e.g., AF 1460), edge computing or fog computing systems, etc. In such embodiments, the NEF 1452 may authenticate, authorize, or throttle the AFs. NEF 1452 may also translate information exchanged with the AF 1460 and information exchanged with internal network functions. For example, the NEF 1452 may translate between an AF-Service-Identifier and an internal 5GC information. NEF 1452 may also receive information from other NFs based on exposed capabilities of other NFs. This information may be stored at the NEF 1452 as structured data, or at a data storage NF using standardized interfaces. The stored information can then be re-exposed by the NEF 1452 to other NFs and AFs, or used for other purposes such as analytics. Additionally, the NEF 1452 may exhibit an Nnef service-based interface.

The NRF 1454 may support service discovery functions, receive NF discovery requests from NF instances, and provide the information of the discovered NF instances to the NF instances. NRF 1454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1454 may exhibit the Nnrf service-based interface.

The PCF 1456 may provide policy rules to control plane functions to enforce them, and may also support unified policy framework to govern network behavior. The PCF 1456 may also implement a front end to access subscription information relevant for policy decisions in a UDR of the UDM 1458. In addition to communicating with functions over reference points as shown, the PCF 1456 exhibit an Npcf service-based interface.

The UDM 1458 may handle subscription-related information to support the network entities' handling of communication sessions, and may store subscription data of UE 1402. For example, subscription data may be communicated via an N8 reference point between the UDM 1458 and the AMF 1444. The UDM 1458 may include two parts, an application front end and a UDR. The UDR may store subscription data and policy data for the UDM 1458 and the PCF 1456, and/or structured data for exposure and application data (including PFDs for application detection, application request information for multiple UEs 1402) for the NEF 1452. The Nudr service-based interface may be exhibited by the UDR 221 to allow the UDM 1458, PCF 1456, and NEF 1452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1458 may exhibit the Nudm service-based interface.

The AF 1460 may provide application influence on traffic routing, provide access to NEF, and interact with the policy framework for policy control.

In some embodiments, the 5GC 1440 may enable edge computing by selecting operator/3rd party services to be geographically close to a point that the UE 1402 is attached to the network. This may reduce latency and load on the network. To provide edge-computing implementations, the 5GC 1440 may select a UPF 1448 close to the UE 1402 and execute traffic steering from the UPF 1448 to data network 1436 via the N6 interface. This may be based on the UE subscription data, UE location, and information provided by the AF 1460. In this way, the AF 1460 may influence UPF (re) selection and traffic routing. Based on operator deployment, when AF 1460 is considered to be a trusted entity, the network operator may permit AF 1460 to interact directly with relevant NFs. Additionally, the AF 1460 may exhibit an Naf service-based interface.

The data network 1436 may represent various network operator services, Internet access, or third party services that may be provided by one or more servers including, for example, application/content server 1438.

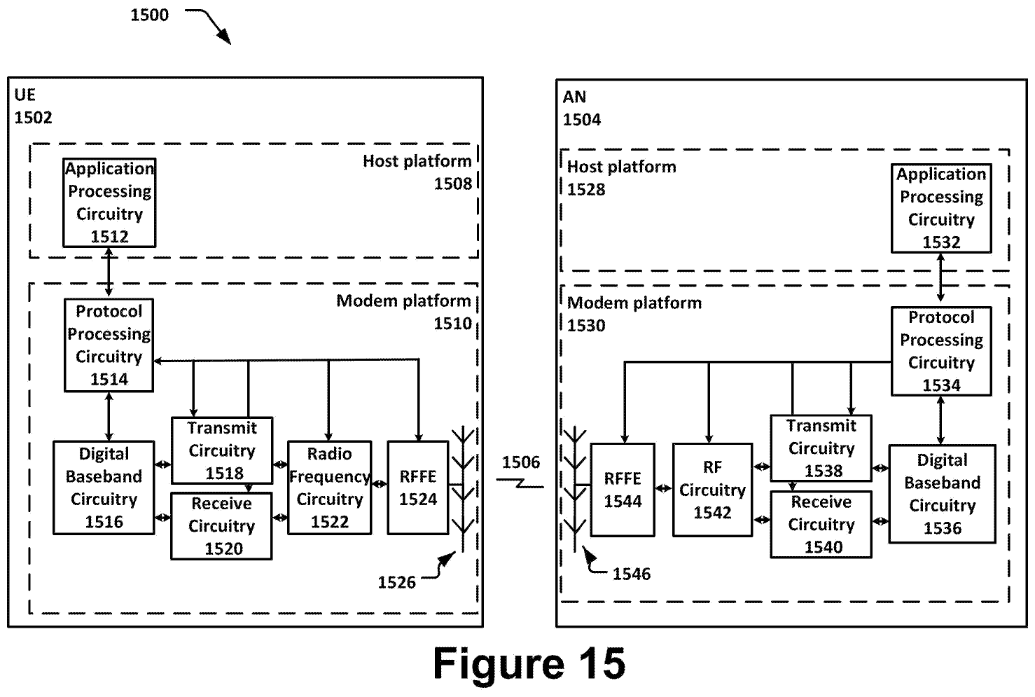

FIG. 15 schematically illustrates a wireless network 1500 in accordance with various embodiments. The wireless network 1500 may include a UE 1502 in wireless communication with an AN 1504. The UE 1502 and AN 1504 may be similar to, and substantially interchangeable with, like-named components described elsewhere herein.

The UE 1502 may be communicatively coupled with the AN 1504 via connection 1506. The connection 1506 is illustrated as an air interface to enable communicative coupling, and can be consistent with cellular communications protocols such as an LTE protocol or a 5G NR protocol operating at mmWave or sub-6 GHZ frequencies.

The UE 1502 may include a host platform 1508 coupled with a modem platform 1510. The host platform 1508 may include application processing circuitry 1512, which may be coupled with protocol processing circuitry 1514 of the modem platform 1510. The application processing circuitry 1512 may run various applications for the UE 1502 that source/sink application data. The application processing circuitry 1512 may further implement one or more layer operations to transmit/receive application data to/from a data network. These layer operations may include transport (for example UDP) and Internet (for example, IP) operations

The protocol processing circuitry 1514 may implement one or more of layer operations to facilitate transmission or reception of data over the connection 1506. The layer operations implemented by the protocol processing circuitry 1514 may include, for example, MAC, RLC, PDCP, RRC and NAS operations.

The modem platform 1510 may further include digital baseband circuitry 1516 that may implement one or more layer operations that are “below” layer operations performed by the protocol processing circuitry 1514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1510 may further include transmit circuitry 1518, receive circuitry 1520, RF circuitry 1522, and RF front end (RFFE) 1524, which may include or connect to one or more antenna panels 1526. Briefly, the transmit circuitry 1518 may include a digital-to-analog converter, mixer, intermediate frequency (IF) components, etc.; the receive circuitry 1520 may include an analog-to-digital converter, mixer, IF components, etc.; the RF circuitry 1522 may include a low-noise amplifier, a power amplifier, power tracking components, etc.; RFFE 1524 may include filters (for example, surface/bulk acoustic wave filters), switches, antenna tuners, beamforming components (for example, phase-array antenna components), etc. The selection and arrangement of the components of the transmit circuitry 1518, receive circuitry 1520, RF circuitry 1522, RFFE 1524, and antenna panels 1526 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1514 may include one or more instances of control circuitry (not shown) to provide control functions for the transmit/receive components.

A UE reception may be established by and via the antenna panels 1526, RFFE 1524, RF circuitry 1522, receive circuitry 1520, digital baseband circuitry 1516, and protocol processing circuitry 1514. In some embodiments, the antenna panels 1526 may receive a transmission from the AN 1504 by receive-beamforming signals received by a plurality of antennas/antenna elements of the one or more antenna panels 1526.

A UE transmission may be established by and via the protocol processing circuitry 1514, digital baseband circuitry 1516, transmit circuitry 1518, RF circuitry 1522, RFFE 1524, and antenna panels 1526. In some embodiments, the transmit components of the UE 1504 may apply a spatial filter to the data to be transmitted to form a transmit beam emitted by the antenna elements of the antenna panels 1526.

Similar to the UE 1502, the AN 1504 may include a host platform 1528 coupled with a modem platform 1530. The host platform 1528 may include application processing circuitry 1532 coupled with protocol processing circuitry 1534 of the modem platform 1530. The modem platform may further include digital baseband circuitry 1536, transmit circuitry 1538, receive circuitry 1540, RF circuitry 1542, RFFE circuitry 1544, and antenna panels 1546. The components of the AN 1504 may be similar to and substantially interchangeable with like-named components of the UE 1502. In addition to performing data transmission/reception as described above, the components of the AN 1508 may perform various logical functions that include, for example, RNC functions such as radio bearer management, uplink and downlink dynamic radio resource management, and data packet scheduling.

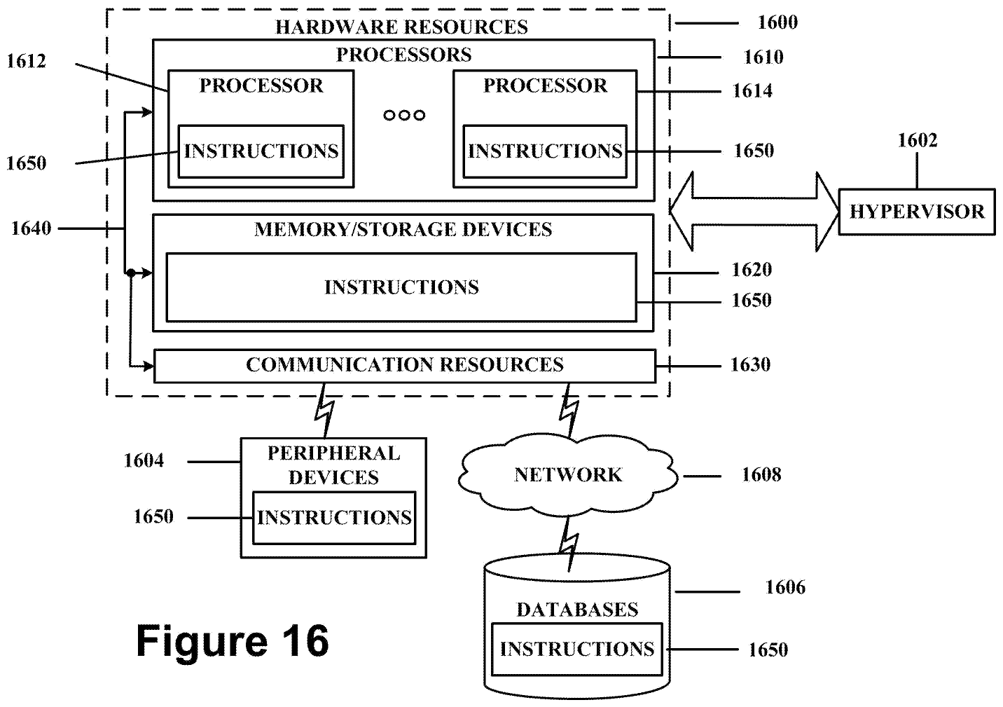

FIG. 16 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1600 including one or more processors (or processor cores) 1610, one or more memory/storage devices 1620, and one or more communication resources 1630, each of which may be communicatively coupled via a bus 1640 or other interface circuitry. For embodiments where node virtualization (e.g., NFV) is utilized, a hypervisor 1602 may be executed to provide an execution environment for one or more network slices/sub-slices to utilize the hardware resources 1600.

The processors 1610 may include, for example, a processor 1612 and a processor 1614. The processors 1610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1620 may include main memory, disk storage, or any suitable combination thereof. The memory/storage devices 1620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1630 may include interconnection or network interface controllers, components, or other suitable devices to communicate with one or more peripheral devices 1604 or one or more databases 1606 or other network elements via a network 1608. For example, the communication resources 1630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1650 may comprise software, a program, an application, an applet, an app, or other executable code for causing at least any of the processors 1610 to perform any one or more of the methodologies discussed herein. The instructions 1650 may reside, completely or partially, within at least one of the processors 1610 (e.g., within the processor's cache memory), the memory/storage devices 1620, or any suitable combination thereof. Furthermore, any portion of the instructions 1650 may be transferred to the hardware resources 1600 from any combination of the peripheral devices 1604 or the databases 1606. Accordingly, the memory of processors 1610, the memory/storage devices 1620, the peripheral devices 1604, and the databases 1606 are examples of computer-readable and machine-readable media.

### Example Procedures

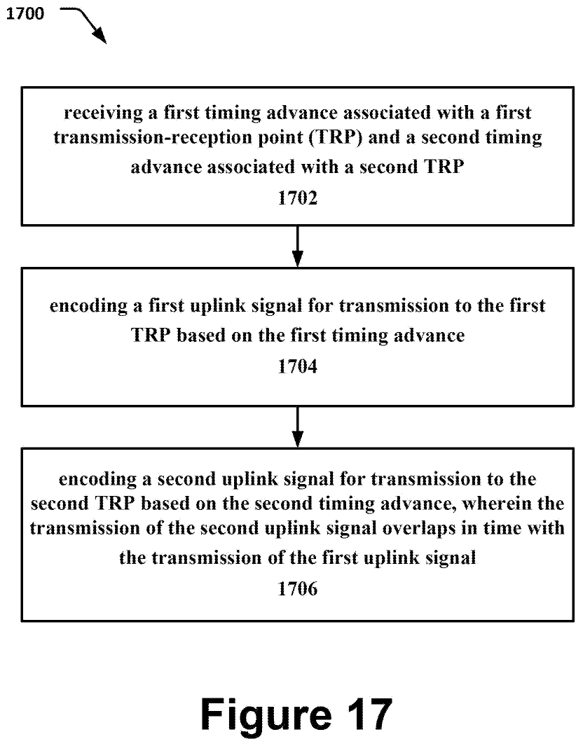

In some embodiments, the electronic device(s), network(s), system(s), chip(s) or component(s), or portions or implementations thereof, of FIGS. 14-16, or some other figure herein, may be configured to perform one or more processes, techniques, or methods as described herein, or portions thereof. One such process 1700 is depicted in FIG. 17. In some embodiments, the process 1700 may be performed by a UE or a portion thereof. At 1702, the process 1700 may include receiving a first timing advance associated with a first transmission-reception point (TRP) and a second timing advance associated with a second TRP. At 1704, the process 1700 may further include encoding a first uplink signal for transmission to the first TRP based on the first timing advance. At 1706, the process 1700 may further include encoding a second uplink signal for transmission to the second TRP based on the second timing advance, wherein the transmission of the second uplink signal overlaps in time with the transmission of the first uplink signal.

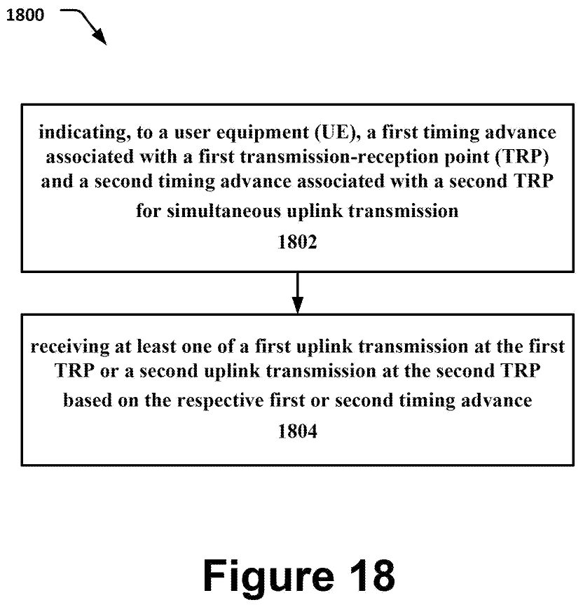

FIG. 18 illustrates another example process 1800 in accordance with various embodiments. In some embodiments, the process 1800 may be performed by a gNB or a portion thereof. At 1802, the process 1800 may include indicating, to a user equipment (UE), a first timing advance associated with a first transmission-reception point (TRP) and a second timing advance associated with a second TRP for simultaneous uplink transmission. At 1804, the process 1800 may further include receiving at least one of a first uplink transmission at the first TRP or a second uplink transmission at the second TRP based on the respective first or second timing advance.

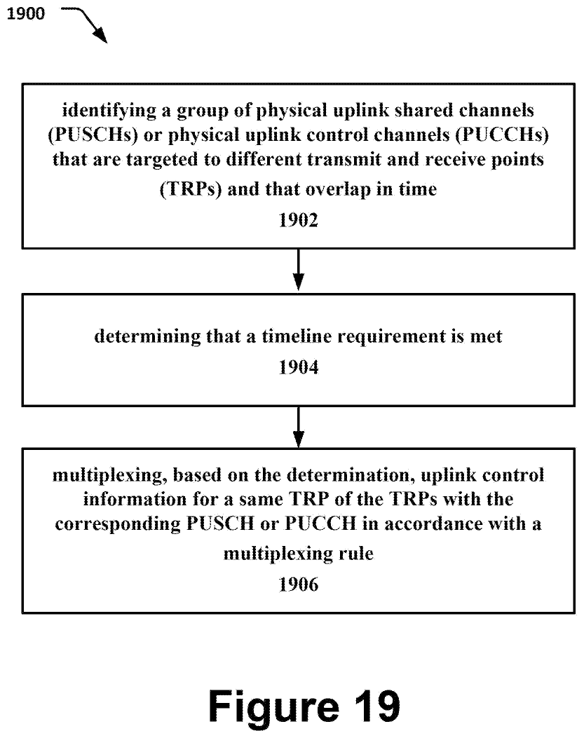

FIG. 19 illustrates another example process 1900 in accordance with various embodiments. In some embodiments, the process 1900 may be performed by a UE or a portion thereof. At 1902, the process 1900 may include identifying a group of physical uplink shared channels (PUSCHs) or physical uplink control channels (PUCCHs) that are targeted to different transmit and receive points (TRPs) and that overlap in time. At 1904, the process 1900 may further include determining that a timeline requirement is met. At 1906, the process 1900 may further include multiplexing, based on the determination, uplink control information for a same TRP of the TRPs with the corresponding PUSCH or PUCCH in accordance with a multiplexing rule.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example A1 may include one or more non-transitory computer-readable media (NTCRM) having instructions, stored thereon, that when executed by one or more processors of a user equipment (UE) configure the UE to: receive a first timing advance associated with a first transmission-reception point (TRP) and a second timing advance associated with a second TRP; encode a first uplink signal for transmission to the first TRP based on the first timing advance; and encode a second uplink signal for transmission to the second TRP based on the second timing advance, wherein the transmission of the second uplink signal overlaps in time with the transmission of the first uplink signal.

Example A2 may include the one or more NTCRM of Example A1, wherein the first timing advance is received in a medium access control (MAC) control element (CE), wherein the MAC CE includes a bit to indicate that the first timing advance corresponds to the first TRP.

Example A3 may include the one or more NTCRM of Example A2, wherein the MAC CE is a first MAC CE, and wherein the second timing advance is received in a second MAC CE.

Example A4 may include the one or more NTCRM of Example A1, wherein the second timing advance is received as a timing offset with respect to the first timing advance.

Example A5 may include the one or more NTCRM of Example A1, wherein the first timing advance is associated with a first control resource set (CORESET) pool index, and the second timing advance is associated with a second CORESET pool index.

Example A6 may include the one or more NTCRM of Example A5, wherein the first uplink signal is scheduled by a first physical downlink control channel (PDCCH) associated with the first CORESET pool index and the second uplink signal is scheduled by a second PDCCH associated with the second CORESET pool index.

Example A7 may include the one or more NTCRM of any one of Examples A1-6, wherein the first and second signals each include a physical uplink shared channel (PUSCH), a physical uplink control channel (PUCCH), or a sounding reference signal (SRS).

Example A8 may include one or more non-transitory computer-readable media (NTCRM) having instructions, stored thereon, that when executed by one or more processors of a next generation Node B (gNB) configure the gNB to: indicate, to a user equipment (UE), a first timing advance associated with a first transmission-reception point (TRP) and a second timing advance associated with a second TRP for simultaneous uplink transmission; and receive at least one of a first uplink transmission at the first TRP or a second uplink transmission at the second TRP based on the respective first or second timing advance.

Example A9 may include the one or more NTCRM of Example A8, wherein the first timing advance is indicated in a medium access control (MAC) control element (CE), wherein the MAC CE includes a bit to indicate that the first timing advance corresponds to the first TRP.

Example A10 may include the one or more NTCRM of Example A9, wherein the MAC CE is a first MAC CE, and wherein the second timing advance is indicated in a second MAC CE.

Example A11 may include the one or more NTCRM of Example A8, wherein the second timing advance is indicated as a timing offset with respect to the first timing advance.

Example A12 may include the one or more NTCRM of Example A8, wherein the first timing advance is associated with a first control resource set (CORESET) pool index, and the second timing advance is associated with a second CORESET pool index.

Example A13 may include the one or more NTCRM of Example A12, wherein the instructions, when executed, further configure the gNB to: encode, for transmission to the UE in a first CORESET associated with the first CORESET pool index, a first physical downlink control channel (PDCCH) to schedule the first uplink transmission; and encode, for transmission to the UE in a second CORESET associated with the second CORESET pool index, a second PDCCH to schedule the second uplink transmission.

Example A14 may include the one or more NTCRM of any one of Examples A8-13, wherein the first and second uplink transmissions each include a physical uplink shared channel (PUSCH), a physical uplink control channel (PUCCH), or a sounding reference signal (SRS).

Example A15 may include one or more non-transitory computer-readable media (NTCRM) having instructions, stored thereon, that when executed by one or more processors of a user equipment (UE) configure the UE to: identify a group of physical uplink shared channels (PUSCHs) or physical uplink control channels (PUCCHs) that are targeted to different transmit and receive points (TRPs) and that overlap in time; determine that a timeline requirement is met; and multiplex, based on the determination, uplink control information for a same TRP of the TRPs with the corresponding PUSCH or PUCCH in accordance with a multiplexing rule.

Example A16 may include the one or more NTCRM of Example A15, wherein the instructions, when executed, further configure the UE to: receive configuration information to indicate an association between a TRP index and a panel index; and receive a downlink control information (DCI) to schedule one or more of the PUSCHs or PUCCHs, wherein the DCI indicates the TRP index or the panel index for the respective PUSCH or PUCCH.

Example A17 may include the one or more NTCRM of Example A15, wherein the TRPs are associated with respective control resource set (CORESET) pool indexes.

Example A18 may include the one or more NTCRM of Example A17, wherein the instructions, when executed, are further to configure the UE to receive a downlink control information (DCI) to schedule one or more of the PUSCHs or the PUCCHs, wherein the DCI indicates whether the PUSCHs or PUCCHs are to use a same CORESET pool index or a different CORESET pool index from the DCI.

Example A19 may include the one or more NTCRM of Example A15, wherein one or more of the PUSCHs are configured grant PUSCHs, and wherein a ConfiguredGrantConfig configuration for the one or more PUSCHs indicates at least one of a panel index, a TRP index, or a control resource set (CORESET) pool index associated with the one or more PUSCHs.

Example A20 may include the one or more NTCRM of any one of Examples A15-19, wherein the group of PUSCHs or PUCCHs include PUSCHs or PUCCHs with different priorities, and wherein the instructions, when executed, further configure the UE to: resolve overlapping PUCCHs or PUSCHs with a same priority for the same TRP; then resolve overlapping PUCCHs or PUSCHs with different priorities for the same TRP; and then resolve overlap between resulting PUCCHs or PUSCHs for different TRPs.

Example A21 may include the one or more NTCRM of Example A20, wherein to resolve the overlap between the resulting PUCCHs or PUSCHs for different TRPs includes to: if the resulting PUCCHs or PUSCHs for different TRPs have different priorities and overlap in time, drop the resulting PUCCH or PUSCH with lower priority; and if the resulting PUCCHs or PUSCHs for different TRPs have the same priority and overlap in time, transmit the resulting PUCCHs or PUSCHs are simultaneously.

Example B1 may include a method of wireless communication for a fifth generation (5G) or new radio (NR) system, the method comprising:
determining, by UE, a group of physical uplink shared channels (PUSCH) and/or physical uplink control channels (PUCCH) targeted for different transmit and receive points (TRP) that overlap in time; and
multiplexing, by the UE, uplink control information for the same TRP in accordance with the existing multiplexing rule if the timeline requirement is met.

Example B2 may include the method of Example B1 or some other example herein, wherein indication of TRP index or panel index may be explicitly indicated in the downlink control information (DCI) for scheduling; wherein panel index and association between panel and TRP index may be defined and configured by the higher layers.

Example B3 may include the method of Example B1 or some other example herein, wherein TRP index or panel index for multi-TRP multi-panel operation may be associated with coresetPoolIndex in ControlResourceSets

Example B4 may include the method of Example B1 or some other example herein, wherein one-bit field in the DCI may be used to indicate whether same or different coresetPoolIndex as the CORESET for scheduling DCI is used for PUSCH and/or PUCCH transmission

Example B5 may include the method of Example B1 or some other example herein, wherein for configured grant PUSCH, panel index, or TRP index or associated coresetPoolIndex can be configured as part of ConfiguredGrantConfig configuration.

Example B6 may include the method of Example B1 or some other example herein, wherein for multi-TRP multi-panel operation, when a group of PUSCHs and/or PUCCHs targeted for different TRPs overlap in time, and if the timeline requirement as defined in Section 9.2.5 in TS38.213 is satisfied, UCI multiplexing or PUCCH/PUSCH cancellation is performed on PUSCH and/or PUCCH for the same TRP based on existing mechanism

Example B7 may include the method of Example B1 or some other example herein, wherein when two PUSCHs for two TRPs overlap with PUCCH for one TRP, if the timeline requirement as defined in Section 9.2.5 in TS38.213 [1] is satisfied, UCI is multiplexed on the PUSCH for the same TRP, and the PUCCH is dropped

Example B8 may include the method of Example B1 or some other example herein, wherein for multi-TRP multi-panel operation, when a group of PUSCHs and/or PUCCHs targeted for different TRPs overlap in time, and if the timeline requirement as defined in Section 9.2.5 in TS38.213 is satisfied, UCI multiplexing or PUCCH/PUSCH cancellation is performed on PUSCH and/or PUCCH for all the TRPs based on existing mechanism as defined in Rel-15/16/17.

Example B9 may include the method of Example B1 or some other example herein, wherein for multi-TRP multi-panel operation, when a group of PUSCHs and/or PUCCHs targeted for different TRPs overlap in time, and if the timeline requirement as defined in Section 9.2.5 in TS38.213 is satisfied, UCI multiplexing or PUCCH/PUSCH cancellation is performed on PUSCH and/or PUCCH on the TRP with lowest index based on existing mechanism.

Example B10 may include the method of Example B1 or some other example herein, wherein for multi-TRP multi-panel operation, if the timeline requirement as defined in Section 9.2.5 in TS38.213 is satisfied, the following procedure can be used to handle overlapping

PUCCHs/PUSCHs with different priorities, 1) Step 1: resolve overlapping PUCCHs and/or PUSCHs with same priority for the same TRP 2) Step 2: resolve overlapping PUCCHs and/or PUSCH with different priorities for the same TRP: 3) Step 3: if the resulting PUCCHs and/or PUSCHs with different TRPs have different priorities and if they overlap in time, the resulting PUCCHs and/or PUSCHs with low priority are cancelled or dropped. If the resulting PUCCHs and/or PUSCHs with different TRPs have same priority, UE may transmit the resulting PUCCHs and/or PUSCH for different TRPs simultaneously.

Example B11 may include the method of Example B1 or some other example herein, wherein for multi-TRP multi-panel operation, if the timeline requirement as defined in Section 9.2.5 in TS38.213 is satisfied, the following procedure can be used to handle overlapping PUCCHs/PUSCHs with different priorities: 1) Step 1: resolve overlapping PUCCHs and/or PUSCHs with same priority for the same TRP 2) Step 2: resolve overlapping PUCCHs and/or PUSCH with different priorities, regardless of TRP index.

Example B12 may include the method of Example B1 or some other example herein, wherein for multi-TRP multi-panel operation, if the timeline requirement as defined in Section 9.2.5 in TS38.213 is satisfied, the following procedure can be used to handle overlapping PUCCHs/PUSCHs with different priorities: 1) Step 1: resolve overlapping PUCCHs and/or PUSCHs with same priority for all the TRPs, 2) Step 2: resolve overlapping PUCCHs and/or PUSCH with different priorities for all the TRPs.

Example B13 may include a method of a user equipment (UE), the method comprising:
identifying a group of physical uplink shared channels (PUSCHs) and/or physical uplink control channels (PUCCHs) that are targeted to different transmit and receive points (TRPs) and that overlap in time;
determining that a timeline requirement is met; and
multiplexing, based on the determination, uplink control information for a same TRP of the TRPs in accordance with a multiplexing rule.

Example B14 may include the method of Example B13 or some other example herein, further comprising receiving a downlink control information (DCI) that indicates a TRP index or a panel index associated with the TRPs; and
receiving configuration information to indicate an association between the TRP index and the panel index.

Example B15 may include the method of Example B13-14 or some other example herein, wherein the TRP index or the panel index for multi-TRP multi-panel operation with the TRPs is associated with a coresetPoolIndex in ControlResourceSets

Example B16 may include the method of Example B13-15 or some other example herein, further comprising receiving a DCI to schedule one or more of the PUSCHs and/or PUCCHs, wherein the DCI includes an indicator to indicate whether the PUSCHs and/or PUCCHs are to use a same coresetPoolIndex or a different coresetPool Index from a CORESET used for the DCI.

Example B17 may include the method of Example B1 or some other example herein, wherein one or more of the PUSCHs are configured grant PUSCHs, and wherein a ConfiguredGrantConfig configuration for the one or more PUSCHs indicates a panel index, a TRP index, and/or a coresetPoolIndex associated with the one or more PUSCHs.
Example C1 may include methods of timing advance computation and indication in simultaneous multi-TRP UL transmission schemes, where the methods include:
option 1: a TRP-specific TA reporting,
option 2: a TA reporting with a reference TA and a TA difference,
option 3: a TRP-specific TA reporting where the TRPs are perfect synchronized,
associating the TRPs with the TAs, with RRC, MAC CE, or DCI indication.

Example C2 may include the methods in Example C1 or some other example herein, where for option1, two separate TACs can be distinguished by the reserved field in a TA MAC CE.

Example C3 may include the methods in Example C1 or some other example herein, where for option 2, the TRP corresponding to the reference TA can be indicated by the reserved field in the MAC CE.

Example C4 may include the methods in Example C1 or some other example herein, where for option 2, whether the MAC CE contains a normal TA or a TA difference can be indicated by the reserved field in the MAC CE.

Example C5 may include the methods in Example C1 or some other example herein, where for option 3, the TRP corresponding to the TA can be indicated by the reserved field in the MAC CE.

Example C6 may include the methods in Example C1 or some other example herein, where TA1 and TA2 can be associated with uplink transmission associated with CORESETPoolIndex values 0 and 1.

Example C7 may include the methods in Example C1 or some other example herein, where a PUCCH resource or a SRS resource or a configured grant can be associated with a TRP-index taking values 0 or 1

Example C8 includes a method of a next-generation NodeB (gNB) comprising:
measuring a first timing advance (TA) value (TA1) associated with a first transmission reception point (TRP1) and a second TA value (TA2) associated with a second TRP (TRP2);
determining a timing advance command (TAC) based on TA1 and TA2; and
encoding a message for transmission to a user equipment (UE) that includes an indication of the TAC in a medium access control (MAC) control element (CE).

Example C9 includes the method of Example C8 or some other example herein, wherein the MAC CE includes a field (R) to distinguish between TRP1 and TRP2.

Example C10 includes a method of a user equipment (UE) comprising:
determining a second TA value (TA2) based on a local timing difference (LTD), a first TA value (TA1), and a TA difference between an uplink (UL) to a first transmission reception point (TRP1) and an UL to a second TRP (TRP2); and
encoding messages for simultaneous UL transmission to TRP1 based on TA1 and to TRP2 based on TA2.

Example C11 includes the method of Example C10 or some other example herein, wherein TA1 and the TA difference are received from a next-generation NodeB (gNB) via a medium access control (MAC) control element (CE).

Example C12 includes a method of a user equipment (UE) comprising:
measuring a downlink (DL) reception time difference between a first DL signal from a first transmission reception point (TRP1) and a second DL signal from a second TRP (TRP2), wherein TRP1 and TRP2 are synchronized; and
encoding messages for simultaneous UL transmission to TRP1 and TRP2 based on the DL reception time difference.

Example C13 includes the method of Example C11 or some other example herein, wherein the messages are encoded for transmission based additionally on an indication of a timing advance (TA) received from a gNB via a MAC CE.

Example Z01 may include an apparatus comprising means to perform one or more elements of a method described in or related to any of examples A1-A21, B1-B17, C1-C13, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A21, B1-B17, C1-C13, or any other method or process described herein.

Example Z03 may include an apparatus comprising logic, modules, or circuitry to perform one or more elements of a method described in or related to any of examples A1-A21, B1-B17, C1-C13, or any other method or process described herein.

Example Z04 may include a method, technique, or process as described in or related to any of examples A1-A21, B1-B17, C1-C13, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A21, B1-B17, C1-C13, or portions thereof.

Example Z06 may include a signal as described in or related to any of examples A1-A21, B1-B17, C1-C13, or portions or parts thereof.

Example Z07 may include a datagram, packet, frame, segment, protocol data unit (PDU), or message as described in or related to any of examples A1-A21, B1-B17, C1-C13, or portions or parts thereof, or otherwise described in the present disclosure.

Example Z08 may include a signal encoded with data as described in or related to any of examples A1-A21, B1-B17, C1-C13, or portions or parts thereof, or otherwise described in the present disclosure.

Example Z09 may include a signal encoded with a datagram, packet, frame, segment, protocol data unit (PDU), or message as described in or related to any of examples A1-A21, B1-B17, C1-C13, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A21, B1-B17, C1-C13, or portions thereof.

Example Z11 may include a computer program comprising instructions, wherein execution of the program by a processing element is to cause the processing element to carry out the method, techniques, or process as described in or related to any of examples A1-A21, B1-B17, C1-C13, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACR Application Context Relocation
ACK Acknowledgement
ACID Application Client Identification
AF Application Function
AM Acknowledged Mode
AMBRAggregate Maximum Bit Rate
AMF Access and Mobility Management Function
AN Access Network
ANR Automatic Neighbour Relation
AOA Angle of Arrival
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CDR Charging Data Request
CDR Charging Data Response
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICHCommon Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
EAS Edge Application Server
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMAFrequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IIOT Industrial Internet of Things
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LMF Location Management Function
LOS Line of Sight
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOTMaximum Channel Occupancy Time
MCS Modulation and coding scheme
MDAFManagement Data Analytics Function
MDASManagement Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAINetwork Slice Selection Assistance Information
S-NNSAI Single-NSSAI
NSSF Network Slice Selection Function
NW Network
NWUSNarrowband wake-up signal, Narrowband WUS
NZP Non-Zero Power
O&M Operation and Maintenance
ODU2 Optical channel Data Unit - type 2
OFDMOrthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSFCH physical sidelink feedback channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDT Small Data Transmission
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLANWireless Local Area Network
WMAN Wireless Metropolitan Area Network
WPANWireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-21. (canceled)

22. An apparatus for use in a user equipment (UE), wherein the apparatus comprises:
memory to store a received a first timing advance associated with a first transmission-reception point (TRP) and a second timing advance associated with a second TRP; and
one or more processors configured to:
encode a first uplink signal for transmission to the first TRP based on the first timing advance; and
encode a second uplink signal for transmission to the second TRP based on the second timing advance, wherein the transmission of the second uplink signal overlaps in time with the transmission of the first uplink signal.

23. The apparatus of claim 22, wherein the first timing advance is received in a medium access control (MAC) control element (CE), wherein the MAC CE includes a bit to indicate that the first timing advance corresponds to the first TRP.

24. The apparatus of claim 23, wherein the MAC CE is a first MAC CE, and wherein the second timing advance is received in a second MAC CE.

25. The apparatus of claim 22, wherein the second timing advance is received as a timing offset with respect to the first timing advance.

26. The apparatus of claim 22, wherein the first timing advance is associated with a first control resource set (CORESET) pool index, and the second timing advance is associated with a second CORESET pool index.

27. The apparatus of claim 26, wherein the first uplink signal is scheduled by a first physical downlink control channel (PDCCH) associated with the first CORESET pool index and the second uplink signal is scheduled by a second PDCCH associated with the second CORESET pool index.

28. The apparatus of claim 22, wherein the first and second signals each include a physical uplink shared channel (PUSCH), a physical uplink control channel (PUCCH), or a sounding reference signal (SRS).

29. One or more non-transitory computer-readable media (NTCRM) having instructions, stored thereon, that when executed by one or more processors of a next generation Node B (gNB) configure the gNB to:
indicate, to a user equipment (UE), a first timing advance associated with a first transmission-reception point (TRP) and a second timing advance associated with a second TRP for simultaneous uplink transmission; and
receive at least one of a first uplink transmission at the first TRP or a second uplink transmission at the second TRP based on the respective first or second timing advance.

30. The one or more NTCRM of claim 29, wherein the first timing advance is indicated in a medium access control (MAC) control element (CE), wherein the MAC CE includes a bit to indicate that the first timing advance corresponds to the first TRP.

31. The one or more NTCRM of claim 30, wherein the MAC CE is a first MAC CE, and wherein the second timing advance is indicated in a second MAC CE.

32. The one or more NTCRM of claim 29, wherein the second timing advance is indicated as a timing offset with respect to the first timing advance.

33. The one or more NTCRM of claim 29, wherein the first timing advance is associated with a first control resource set (CORESET) pool index, and the second timing advance is associated with a second CORESET pool index.

34. The one or more NTCRM of claim 33, wherein the instructions, when executed, further configure the gNB to:
encode, for transmission to the UE in a first CORESET associated with the first CORESET pool index, a first physical downlink control channel (PDCCH) to schedule the first uplink transmission; and
encode, for transmission to the UE in a second CORESET associated with the second CORESET pool index, a second PDCCH to schedule the second uplink transmission.

35. The one or more NTCRM of claim 29, wherein the first and second uplink transmissions each include a physical uplink shared channel (PUSCH), a physical uplink control channel (PUCCH), or a sounding reference signal (SRS).

36. One or more non-transitory computer-readable media (NTCRM) having instructions, stored thereon, that when executed by one or more processors of a user equipment (UE) configure the UE to:
identify a group of physical uplink shared channels (PUSCHs) or physical uplink control channels (PUCCHs) that are targeted to different transmit and receive points (TRPs) and that overlap in time;
determine that a timeline requirement is met; and
multiplex, based on the determination, uplink control information for a same TRP of the TRPs with the corresponding PUSCH or PUCCH in accordance with a multiplexing rule.

37. The one or more NTCRM of claim 36, wherein the instructions, when executed, further configure the UE to:
receive configuration information to indicate an association between a TRP index and a panel index; and
receive a downlink control information (DCI) to schedule one or more of the PUSCHs or PUCCHs, wherein the DCI indicates the TRP index or the panel index for the respective PUSCH or PUCCH.

38. The one or more NTCRM of claim 36, wherein the TRPs are associated with respective control resource set (CORESET) pool indexes.

39. The one or more NTCRM of claim 38, wherein the instructions, when executed, are further to configure the UE to receive a downlink control information (DCI) to schedule one or more of the PUSCHs or the PUCCHs, wherein the DCI indicates whether the PUSCHs or PUCCHs are to use a same CORESET pool index or a different CORESET pool index from the DCI.

40. The one or more NTCRM of claim 36, wherein one or more of the PUSCHs are configured grant PUSCHs, and wherein a ConfiguredGrantConfig configuration for the one or more PUSCHs indicates at least one of a panel index, a TRP index, or a control resource set (CORESET) pool index associated with the one or more PUSCHs.

41. The one or more NTCRM of claim 36, wherein the group of PUSCHs or PUCCHs include PUSCHs or PUCCHs with different priorities, and wherein the instructions, when executed, further configure the UE to:
resolve overlapping PUCCHs or PUSCHs with a same priority for the same TRP; then
resolve overlapping PUCCHs or PUSCHs with different priorities for the same TRP; and then
resolve overlap between resulting PUCCHs or PUSCHs for different TRPs.
